(19) United States
(12) Patent Application Publication
(10) Pub. No.: US 2018/0310491 A1
(43) Pub. Date: Nov. 1, 2018

(54) Crop Protection System

(71) Applicant: Michael Anthony Cunial, Nashdale (AU)

(72) Inventor: Michael Anthony Cunial, Nashdale (AU)

(21) Appl. No.: 15/581,931

(22) Filed: Apr. 28, 2017

(51) Int. Cl. A01G 13/02; A01G 13/10; A01G 9/12

(52) U.S. Cl. CPC A01G 13/0206; A01G 9/12; A01G 13/10

(57) ABSTRACT

A crop protection system having a cover for protecting a crop or crop producing plants; a plurality of cover support arms for supporting the cover such that a periphery of the cover is depends downwardly from the cover support arms; a plurality of supports for supporting the respective cover support arms; and a plurality of cover holders configured to hold the periphery of the cover away from the supports. The cover, when deployed, curtains at least in part the crop or crop producing plants.

### BACKGROUND

The invention relates to a crop protection system, of particular but by no means exclusive application in protecting a crop or crop producing plants.

### SUMMARY

One existing system comprises a net that is placed over and supported by crop producing plants. Another existing system includes poles and a net, the net being supported above the crop producing plants by a network of wires supported by the poles.

According to a first broad aspect of the present invention, there is provided a crop protection system comprising:

a cover for protecting a crop (such as fruit) or crop producing plants (such as apple or other fruit trees);

a plurality of cover support arms for supporting the cover such that a periphery of the cover depends downwardly from the cover support arms;

a plurality of supports for supporting the respective cover support arms; and

a plurality of cover holders configured to hold the periphery of the cover away from the supports;

wherein the cover when deployed curtains at least in part the crop or crop producing plants (such as from the elements, pests or diseases).

The cover holders may comprise cover securing members configured to be attached to the respective supports below the respective cover support arms and to be attached to the cover towards the periphery of the cover, or a plurality of guys attached to or attachable to the cover (such as towards its periphery) and securable relative to the ground (whether with pegs, stakes or otherwise).

The cover holders may comprise rods, such as of fiberglass. The cover holders may be adjustable in their location (e.g. height) of attachment to the supports.

The crop protection system may comprise brackets locatable on the supports for attaching the cover holders to the supports.

Generally, each of the supports is configured to support a respective pair of the cover support arms with the respective pair of the cover support arms extending in generally opposite directions from the respective support. The respective pair of the cover support arms may be integral with one another.

Each of one or more of the cover support arms may comprise a plurality of components. The components may be integral, connected to one another, or merely supported adjacent (even if not touching) to one another. At least some of the components may be generally straight. The cover support arms may comprise arcuate members with first and second ends configured to depend downwardly in use.

In an embodiment, each of one or more of the supports comprises a pole or post for use when arranged with an upright orientation.

The cover support arms may be desirably supported at or near the tops of the supports. The cover support arms may be supported by the supports with ends depending downwardly from respective points of attachment to the supports.

However, other forms of supports are contemplated, including frames or arrangements of a plurality poles from which the cover support arms may be suspended.

The cover may comprise a web, a net, a rain cover, a reflective material, or a combination thereof. These may be selected to protect or encourage a growth of the crop or crop producing plants.

The cover may be permanently attached to the cover holders, but in one embodiment the cover is detachably attachable to the cover holders. The cover may be retractable (e.g. upwardly or along the system), such as to provide access to the crop or crop producing plants, such as for thinning, picking or ventilation.

The crop protection system may comprise a growth support structure, such as a trellis. The growth support structure may comprise a plurality of wires, such as supported by the supports. The supports may be configured to engage the plurality of wires such that the plurality of wires are, in use, arranged horizontally.

In an embodiment, the system further comprises one or more webs configured to be supported at least in part by the cover holders so as to at least partially close a volume surrounded by the cover. The webs may comprise a net or an at least partially reflective material arranged to reflect light generally upwardly.

According to a second broad aspect of the present invention, there is provided a crop protection system comprising:

a cover for protecting a crop or crop producing plants;

a plurality of supports for supporting the cover over the crop or crop producing plants with a periphery of the cover depending downwardly from the supports; and

a plurality of cover holders configured to hold the periphery of the cover away from the supports;

wherein the cover when deployed curtains at least in part the crop or crop producing plants.

In an embodiment, the supports comprise respective cover support arms (for example, two cover support arms, which may be integral), wherein the cover support arms are configured to support the cover such that the periphery of the cover depends downwardly from the cover support arms.

It should be noted that any of the various individual features of each of the above aspects of the invention, and any of the various individual features of the embodiments described herein including in the claims, can be combined as suitable and desired.

### BRIEF DESCRIPTION OF THE DRAWINGS

In order that the invention may be more clearly ascertained, embodiments will now be described, by way of example, with reference to the accompanying drawing, in which:

FIG. 1 is a schematic view of a crop protection system according to an embodiment of the present invention, with cover omitted for clarity;

FIG. 2 is a schematic, perspective view of one end of a post of the crop protection system of FIG. 1;

FIG. 3A is a schematic view of the crop protection system of FIG. 1, with cover deployed in a first configuration;

FIG. 3B is a schematic view of the crop protection system of FIG. 1, with cover deployed in a second configuration;

FIG. 4 is a cross-sectional schematic view of a post, cover support member and cover securing member of the crop protection system of FIG. 1, with cover deployed;

FIG. 5 is a schematic view of a bracket and cover securing member of the crop protection system of FIG. 1

FIG. 6 is a schematic view of a pole and cover support member of a crop protection system according to an alternative embodiment;

FIG. 7A is a schematic view of an arrangement for attaching a cover support member central portion to a post of the crop protection system of FIG. 1; and

FIG. 7B is a schematic view of another arrangement for attaching a cover support member central portion to a post of the crop protection system of FIG. 1.

### DETAILED DESCRIPTION

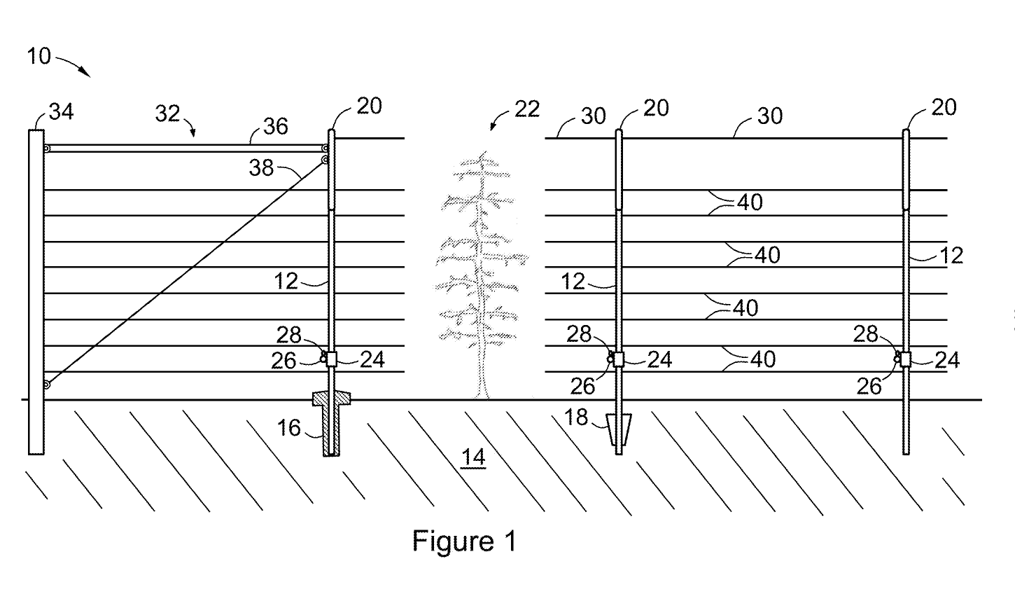

FIG. 1 is a schematic view of a crop protection system 10 according to an embodiment of the present invention. In this figure, the cover (described below) of system 10 has been omitted for clarity.

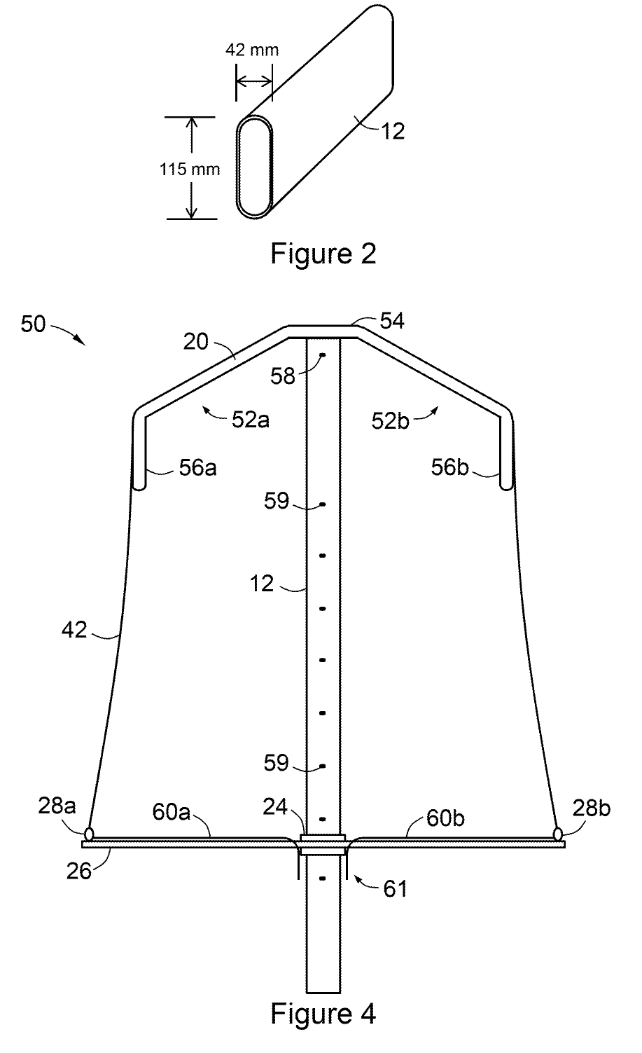

System 10 includes a plurality of upright supports in the form of posts 12, spaced approximately 8 m apart (though it will be appreciated that this separation may be varied according to application and materials). In this embodiment, each of posts 12 is approximately 5.5 m long, being configured to stand about 4.5 m above the ground with 1 m for securing the post in the ground 14; the post are of 2 mm gauge steel, and may be of generally square cross-section (e.g. 50 mm×50 mm), circular (e.g. of 50 mm external diameter), or otherwise—but in any event of sufficient strength to provide and maintain the required support. In this embodiment, each post 12 has an oblong cross section and is arranged with its major axis across the plane approximately defined by system 10 (and hence perpendicular to the figure sheet in this view); each post 12 has cross-sectional dimensions of 115×42 mm, which provides good lateral strength. FIG. 2 is a schematic, perspective view of one end of a post 12, illustrating the shape and relative dimensions of its cross section.

Referring to FIG. 1, posts 12 may be secured into the ground with a concrete boot 16, an anchor plate 18 or otherwise. System 10 includes, surmounting the respective posts 12, cover support arms in the form of cover support arms 20. Each of cover support arms 20 depends from the top of a respective post 12 (as described in more detail below); each has a generally inverted ‘bull-horn’ shape, with first and second ends depending generally downwardly from a central point of attachment to the corresponding post 12. System 10 includes a cover (not shown) that, in use, is supported by cover support arms 20 to protect a crop or crop producing plants 22 (such as apple trees).

System 10 also includes a plurality of brackets 24 attached to the supports 20, and a corresponding plurality of cover holders in the form of cover securing members 26. Cover securing members 26 each comprises a fiberglass rod attached to a respective bracket 24 and extending equidistantly in opposite directions from that bracket 24. An eyelet 28 is provided at each end of each bracket 24 for engagement with a complementary hook attached to the periphery of the cover. Thus, in use, cover securing members 26 hold the periphery of the cover away from supports 12 in a skirt-like arrangement, and hence away from the crop or crop producing plants 22.

In another embodiment, cover securing members 26 may extend to different distances from brackets 24, such as to allow for an asymmetric locating of the crop or crop producing plants 22 beneath the cover. This may be advantageous should it be desired that the growth support structure (described below) of system 10—and hence the centerline of system 10—be offset laterally relative to the crop or crop producing plants 22, such that one arm of cover securing members 26 are desirably longer than the other.

System 10 includes a cover support wire 30 (which also acts as a post stay), supported by each of posts 12 towards the tops of the posts, for supporting the cover between posts 12, and two end assemblies 32 (only one of which is depicted in this figure), one at each end of system 10, for supporting the first and last of posts 12 and hence—by virtue of cover support wire 30—all of posts 12. Each end assembly 32 includes an end post 34 spaced about 5 m from the adjacent standard post 12, a top bar 36 coupling end post 34 to the adjacent post 12, and a diagonal straining wire 38. Each end post 34 is essentially the same as one of standard posts 12, but rotated by 90 degrees such that its oblong cross section is oriented with its major axis generally in the general plane approximately defined by system 10 (and hence in plane of the figure sheet in this view). This orientation gives each end post 34 longitudinal strength for straining purposes.

System 10 also includes a growth support structure in the form of a trellis comprising horizontal growth wires 40 supported by posts 12 and end posts 34. Growth wires 40 are provided to lend support to crop producing plants 22 and hence promote growth. In this embodiment, system 10 includes eight horizontal growth wires 40, spaced apart at a separation of approximately 50 mm, but it will be appreciated that the number and separation may be varied according to application and convenience.

It will be appreciated that FIG. 1 depicts only three posts 12 and only one of end posts 34, but that this is solely for illustrative purposes. In use, system 10 may include as many posts 12 and spans of growth wires 40 as required and as can be accommodated by the available space.

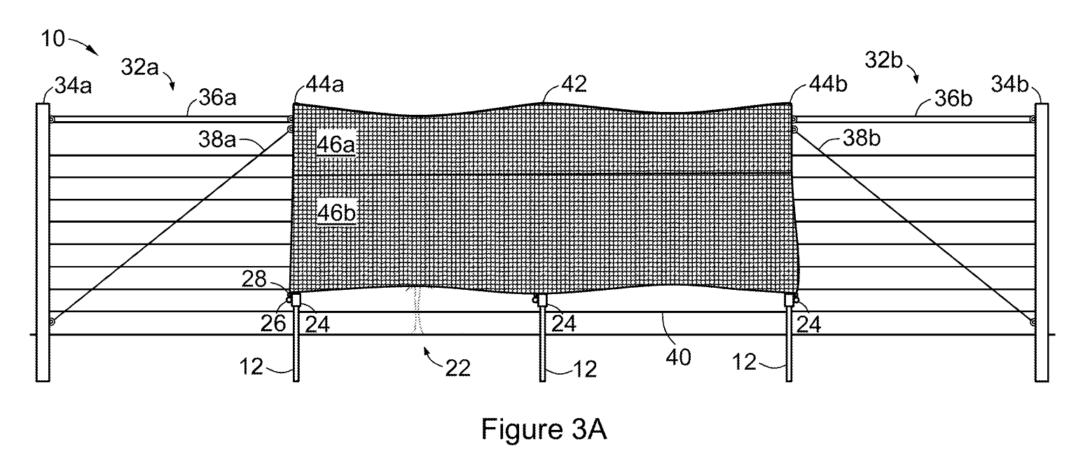

FIG. 3A is a further schematic view of crop protection system 10 of FIG. 1, including a protective cover 42 in one of its deployed configurations. In addition to first and second end assemblies 32a, 32b, FIG. 3A depicts both end posts 34a, 34b but only three posts 12, but this is again solely for illustrative purposes.

Referring to FIG. 3A, cover 42 is draped over cover support arms 20 and hooked to eyelets 28 with detachable clips (not shown) attached to its lower periphery. The first and second ends 44a, 44b of the midline of cover 42 are prevented from pulling away from the first and last of posts 12 (such as under the weight of cover 42) by being suitably secured, such as to the first and last of posts 12 (e.g. by being hooked onto pins extending laterally from the posts), the first and last of cover support arms 20 (e.g. by being hooked onto pins extending upwardly from the arms), or to end posts 34a, 34b (e.g. with cables), respectively.

Cover 42 may be adapted to provide shade, protect the crop or crop producing plants 22 (such as from pests or the elements), reflect excessive insolation, or provide a micro-climate for the crop or crop producing plants 22. To this end, cover 42 may include sections of different material; an upper portion 44a of cover 42, for example, may be rain-resistant or impermeable, while a lower portion 44b may be of netting.

FIG. 3B is a further schematic view of crop protection system 10, comparable to that of FIG. 3A but in another of its deployed configurations. In this configuration, cover 42 has been detached from eyelets and retracted upwards, so that more light (for example) may be admitted to the crops or crop producing plants 22 or to provide increased access to the crops or crop producing plants 22 (such as for fruit thinning or picking). Cover 42 is retracted upwards by unclipping it from eyelets 28 and then pulling it up with a robust draw string or cord (not shown) to rest on or near the respective cover support arms 20.

Alternatively, cover 42 may be retracted drawing one or both ends of cover 42 (cf. the drawing of a curtain), so that the crops or crop producing plants 22 are exposed.

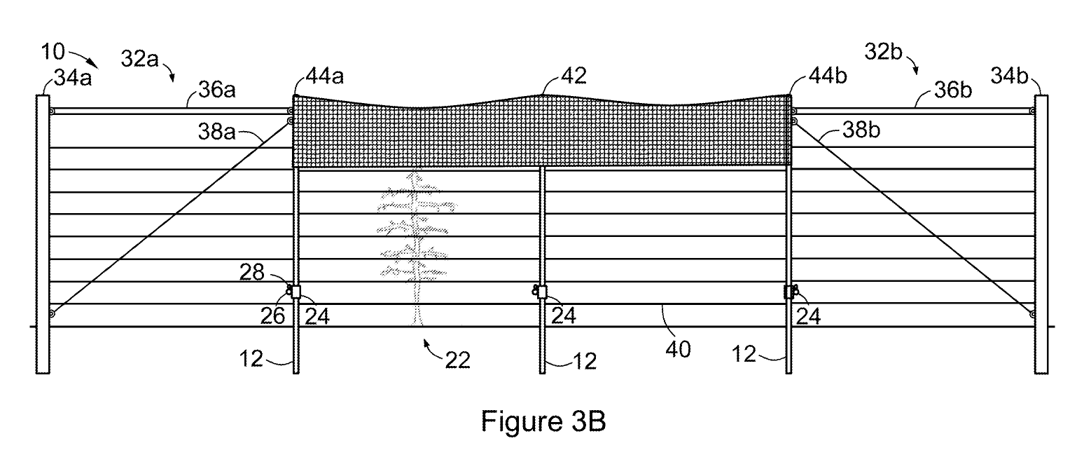

FIG. 4 is a cross-sectional schematic view 50 of a post 12, cover support member 20 and cover securing member 26 of the crop protection system of FIG. 1, with cover 42 deployed in the first configuration (cf. FIG. 3A). As is apparent in this view, in this embodiment cover support member 20 has a generally inverted ‘bull-horn’ shape, with first and second ends 52a, 52b depending generally downwardly from a generally horizontal central portion 54 of cover support member 20 attached to post 12. This attachment may be effected in any convenient way, such as by securing a bracket (not shown) to the top of post 12 for receiving central portion 54 of cover support member 20 and to which central portion 54 may be bolted.

First and second ends 52a, 52b of cover support member 20 angle downwards, but have terminating portions 56a, 56b that depend essentially vertically to minimize wear to cover 42 by cover support member 20.

As is also apparent from this view, post 12 includes an aperture 58 towards its upper end, for receiving cover support wire 30, and trellis apertures 59 for receiving horizontal growth wires 40. Bracket 24, which supports cover securing member 26, surrounds post 12 and is slidable to some degree up and down post 12. In use, bracket 24 is secured in a fixed position by any suitable mechanism. This approach also allows bracket 24 to be moved to a new location between another pair of horizontal growth wires 40, as desired, such as to alter the tension of cover 42.

Although not shown in FIG. 1, 3A or 3B, system 10 may include one or more additional webs 60a, 60b, such as to further exclude pests (such as insects) or herbicide drift, to aid water retention, and/or to reflect light towards the crop or crop producing plants. Webs 60a, 60b are supported, in this embodiment, by cover securing members 26 so as, to a degree, seal in the crop or crop producing plants. In this embodiment, additional webs 60a, 60b are of a reflective material to further exclude insects and herbicide drift, to aid water retention, and to reflect light upwards towards the crop or crop producing plants. Additional webs 60a, 60b are held in place on cover securing members 26 by any suitable mechanism, and in this embodiment with snap clamps (not shown) as well as, optionally, to eyelets 28a, 28b. Such snap clamps may be generally of a split cylindrical form and of a resilient plastics material.

Each of additional webs 60a, 60b is wider than the distance from respective eyelets 28a, 28b apertures 60 (or equivalently to growth wires 40) so as to create a downward directed sleeve 61 wrapped around posts 12, to allow water to drain out while maximizing the seal around posts 12 and optionally crop producing plants (such as tree trunks).

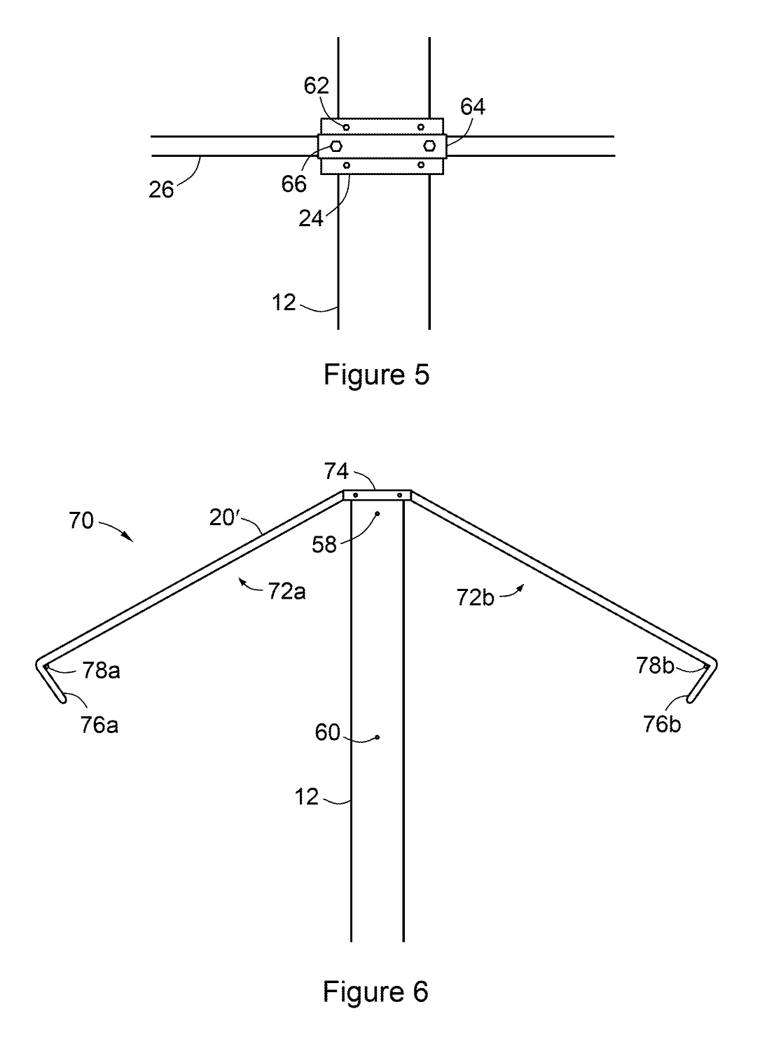

FIG. 5 is a schematic view of bracket 24 located on post 12 and provided with cover securing member 26. Bracket 24 may be provided with grub bolts for holding bracket 24 in place on post 12 (and allow its position to be adjusted vertically), but in this embodiment is screwed to post 12 with screws 62. Bracket 24 may include a sleeve 64 (such as welded to the main body of bracket 24) for receiving and supported cover securing member 26, and one or more fixed nuts/grub bolts 66 to secure cover securing member 26 within sleeve 64. Sleeve 64 is typically sized and shaped to fit cover securing member 26. Optionally, cover securing member 26 may have bores (blind or not) that can be positioned under fixed nuts/grub bolts 66 so as to receive the grub bolts, which can thereby secure cover securing member 26 within sleeve 64.

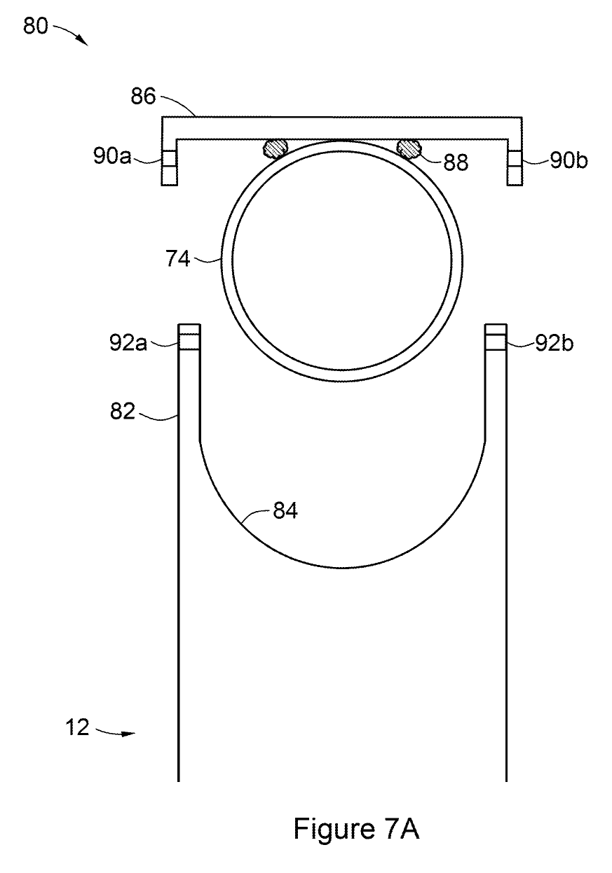

FIG. 6 is a cross-sectional schematic view 70 of a portion of post 12 and a cover support member 20′ according to an alternative embodiment. Cover support member 20′ is also of a generally inverted ‘bull-horn’ shape, with a cap-like central portion 74 attached to or received by the top of post 12, and first and second ends 72a, 72b depending generally downwardly from central portion 74. However, while first and second ends 72a, 72b of cover support member 20′ also angle downwards, terminating portions 76a, 76b are angled towards post 12 to further minimize wear to cover 42.

Cover support member 20′ may include (as indeed may cover support member 20 of FIG. 1), such as at the interior angle where terminating portions 76a, 76b meet first and second ends 72a, 72b, eyelets 78a, 78b, each for receiving and supporting a further pair of cover support wires (not shown). Such cover support wires would desirably extend from the first to the last of posts 12, and provide support to cover 42 between cover support members 20, 20′.

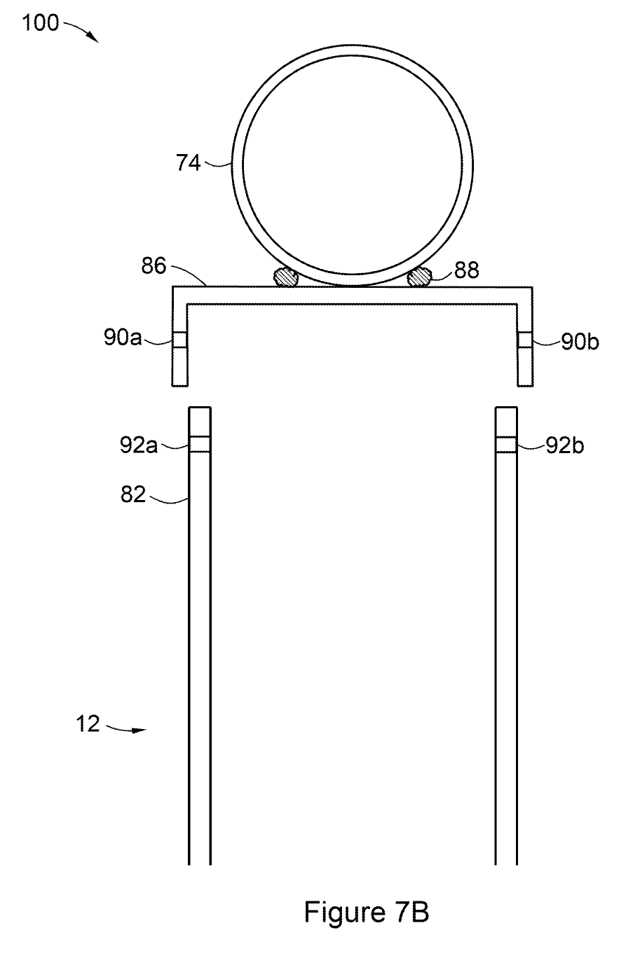

FIG. 7A is a schematic view of one arrangement 80 for attaching cover support member 20, 20′ (and, in particular, its central portion 54, 74) to post 12. FIG. 7A is described by reference to cover support member 20′ of FIG. 6, but is equally relevant to cover support member 20 of FIG. 4. Thus, cover support member 20′ is typically made of tubular steel of about 25 mm external diameter, so the top portion 82 of post 12 is provided with a generally semi-cylindrical cut-out 84 for receiving central portion 74.

A cover plate 86 (in the shape of an inverted U) is welded 88 to the top of central portion 74. Cover plate 86 is provided with two pairs of apertures 90a, 90b and cut-out 84 is provided with corresponding pairs of bores 92a, 92b so that cover plate 86 (and hence central portion 74) may be secured to post 12. This securing may be effected in a number of ways. For example, bores 92a, 92b may be tapped so that bolts (in this example numbering four) inserted through apertures 90a, 90b can be threaded into respective bores 92a, 92b or engage central portion 74.

FIG. 7B is a schematic view of another arrangement 100 for attaching cover support member 20, 20′ (and, in particular, its central portion 54, 74) to post 12. FIG. 7B is also described by reference to cover support member 20′ of FIG. 6, but is equally relevant to cover support member 20 of FIG. 4. In FIGS. 7A and 7B, like reference numerals are used to identify like features.

Referring to FIG. 7B, in arrangement 100, cover support member 20′ is welded 88 to the top of cover plate 86 (again in the shape of an inverted U). Cover plate 86 is provided with two pairs of apertures 90a, 90b and the top 102 of post 12 is provided with corresponding pairs of bores 92a, 92b so that cover plate 86 (and hence central portion 74) may be secured to post 12. This securing may again be effected in a number of ways, such as by tapping bores 92a, 92b so that bolts (in this example numbering four) inserted through apertures 90a, 90b can be threaded into respective bores 92a, 92b or engage post 12.

Modifications within the scope of the invention may be readily effected by those skilled in the art. It is to be understood, therefore, that this invention is not limited to the particular embodiments described by way of example hereinabove.

In the claims that follow and in the preceding description of the invention, except where the context requires otherwise owing to express language or necessary implication, the word “comprise” or variations such as “comprises” or “comprising” is used in an inclusive sense, that is, to specify the presence of the stated features but not to preclude the presence or addition of further features in various embodiments of the invention.

Further, any reference herein to prior art is not intended to imply that such prior art forms or formed a part of the common general knowledge in any country.

1. A crop protection system comprising:
a cover for protecting a crop or crop producing plants;
a plurality of cover support arms for supporting the cover such that a periphery of the cover depends downwardly from the cover support arms;
a plurality of supports for supporting the respective cover support arms; and
a plurality of cover holders configured to hold the periphery of the cover away from the supports;
wherein the cover when deployed curtains at least in part the crop or crop producing plants.

2. A system according to claim 1, wherein the cover holders comprise cover securing members configured to be attached to the respective supports below the respective cover support arms and to be attached to the cover towards the periphery of the cover.

3. A system according to claim 1, wherein the cover holders comprise rods.

4. A system according to claim 2, wherein the cover holders are adjustable in their location of attachment to the supports.

5. A system according to claim 2, further comprising brackets locatable on the supports for attaching the cover holders to the supports.

6. A system according to claim 1, wherein the cover holders comprise a plurality of guys attached to or attachable to the cover and securable relative to the ground.

7. A system according to claim 1, wherein each of the supports is configured to support a respective pair of the cover support arms with the respective pair of the cover support arms extending in generally opposite directions from the respective support.

8. A system according to claim 7, wherein the respective pair of the cover support arms are integral with one another.

9. A system according to claim 7, wherein each of one or more of the cover support arms comprises a plurality of components.

10. A system according to claim 7, wherein the cover support arms comprise arcuate members with first and second ends configured to depend downwardly in use.

11. A system according to claim 1, wherein each of the one or more of the supports comprises a pole or post for use when arranged with an upright orientation.

12. A system according to claim 1, wherein the cover support arms are supported
(i) at or near the tops of the supports, or
(ii) by the supports with ends depending downwardly from respective points of attachment to the supports.

13. A system according to claim 1, wherein the cover (i) comprises a web, a net, a rain cover, a reflective material, or a combination thereof, and/or (ii) is permanently attached to the cover holders.

14. A system according to claim 1, wherein the cover is (i) detachably attachable to the cover holders, and/or (ii) retractable.

15. A system according to claim 1, further comprising a growth support structure.

16. A system according to claim 15, wherein the growth support structure comprises a plurality of wires.

17. A system according to claim 1, further comprising one or more webs configured to be supported at least in part by the cover holders so as to at least partially close a volume surrounded by the cover.

18. A system according to claim 17, wherein the one or more webs comprise a net or an at least partially reflective material arranged to reflect light generally upwardly.

19. A crop protection system comprising:
a cover for protecting a crop or crop producing plants;
a plurality of supports for supporting the cover over the crop or crop producing plants with a periphery of the cover depending downwardly from the supports; and
a plurality of cover holders configured to hold the periphery of the cover away from the supports;
wherein the cover when deployed curtains at least in part the crop or crop producing plants.

20. A system according to claim 19, wherein the supports comprise respective cover support arms, wherein the cover support arms are configured to support the cover such that the periphery of the cover depends downwardly from the cover support arms.
